(19) United States
(12) Patent Application Publication
(10) Pub. No.: US 2003/0177894 A1
(43) Pub. Date: Sep. 25, 2003

(54) Piezo rocker bridge

(76) Inventor: Neil Christopher Skinn, Fort Collins, CO (US)

Correspondence Address: Neil C. Skinn, TransPerformance, LLC, 2513 Pinecone Circle, Fort Collins, CO, 80525-6619, US

(21) Appl. No.: 10/397,859

(22) Filed: Mar. 25, 2003

Related U.S. Application Data
(60) Provisional application No. 60/367,898, filed on Mar. 25, 2002.

(51) Int. Cl. G10H 3/14

(52) U.S. Cl. 84/730

(57) ABSTRACT

A moveable-saddle bridge to be used in conjunction with piezoelectric pickup designs for stringed musical instruments is provided. The device provides substantially frictionless string movement as string tension is adjusted while holding string length fixed. In the preferred embodiment this is accomplished by the use of knife-edge rocker elements that pivot in V-shaped grooves located in carrier pieces that are held in a fixed position. The bridge system is capable of using all types of piezoelectric elements and is especially useful with automatic tuning systems and tremolo devices. The bridge system is useful with respect to a wide variety of musical instruments, e.g., stringed instruments such as guitars, harps, pianos and other instruments.

### CROSS-REFERNENCE TO RELATED APPLICATIONS

This application claims priority to prior U.S. provisional application No. 60/367,898 filed Mar. 25, 2002.

### BACKROUND OF THE INVENTION

Piezoelectric pickups for translating vibrations from the strings of any stringed musical instruments to electronic means for amplification, frequency acquisition, sound reproduction or alteration are known to the art. Piezoelectric pickups and guitar bridges are commonly found in combination; however, none of these combination bridge pickups provide means to allow for frictionless travel of the strings over the bridge saddles. It is therefore an object of this invention to provide a moveable-saddle bridge to be used in conjunction with piezoelectric pickup designs for stringed musical instruments that allow for frictionless travel of the strings over the individual bridge saddles.

String length must be held at a constant length on fretted stringed musical instruments to provide proper string intonation. It is therefore an object of this invention to provide a moveable-saddle bridge to be used in conjunction with piezoelectric pickup designs for stringed musical instruments that hold string intonation length constant as the strings move over the saddles.

Fixed saddles with grooves and roller saddles using rollers riding on pins or bearings have been used to allow for string movement at the bridge when the tension is adjusted in tuning or tremolo systems. These methods produce substantial friction that interferes with tuning accuracy. Thus, it is an object of this invention to provide a moveable-saddle bridge to be used in conjunction with piezoelectric pickup designs for stringed musical instruments with substantially frictionless string movement.

Piezoelectric transducers must be mechanically in vibrational contact with the string in order to produce a conversion of acoustic to electric energy. By “mechanically in vibrational contact” is meant that the vibrations are transmitted physically, through solid media, rather than being sympathetic vibrations. It is therefore an object of this invention to provide a moveable-saddle bridge to be used in conjunction with piezoelectric pickup designs for stringed musical instruments that maximizes the transfer of acoustic energy from the string to the transducer by minimizing the number of material interfaces between the string and the piezoelectricelectric element.

During normal playing of a stringed instrument, the strings are strummed to produce vibrations as well as fretted and bent to change the string length, and hence the frequency of the string. As a result of normal playing, string tension varies producing movement of the string across the bridge saddle. The friction between the string and the saddle preclude the string from returning to its intended frequency. It is therefore an object of this invention to provide a moveable-saddle bridge to be used in conjunction with piezoelectric pickup designs for stringed musical instruments that provides a method by which the friction between the string and bridge saddle is eliminated allowing the string to return to its intended state of tuning.

Patents related to the field providing background information and enablement of various aspects of this invention include U.S. Pat. Nos. 3,712,951, 4,135,426, 4,314,495, 4,657,114, 4,727,634, 4,774,867, 4,860,625, 4,911,057, 4,944,209, 5,029,375, 5,078,041, 5,123,325, 5,204,487, 5,322,969, 6,191,350, 6,198,036, 6,515,214 all of which are incorporated herein by reference to the extent not inconsistent herewith.

### SUMMARY

This invention provides a piezoelectric pickup in combination with a moveable saddle bridge that allows the strings to move over the bridge while using the piezoelectric pickup. The device facilitates string movement at the bridge while keeping the string length constant. The device also allows for adjustment for string intonation length setting, spacing between the strings, string position for matching to curvature of the neck, and bridge height. This invention further provides maximum transfer of acoustic energy form the string to the transducer while providing substantially frictionless string movement. This invention is useful in combination with any musical instrument accessory that requires string movement at the bridge, such as automatic tuning systems and tremolo devices.

This invention also provides a bridge for a musical instrument having at least one string comprising:

at least one rocker element comprising an arced groove for supporting said string, said rocker element having a knife edge which is supported by a carrier with V-shaped groove, said carrier which is housed within a base with a channel to hold said carrier, with a piezoelectric element which is mechanically in vibrational contact with said carrier and said base for converting vibrations transmitted to said piezoelectric element from said string to electronic impulses;

said rocker element being designed to rock in a substantially frictionless manner on said knife edge pivot point in response to tightening or loosening said string in such a manner that the string contacts said rocker elements at a tangent point above said pivot point whereby the string vibration length remains fixed.

Rocker elements for each string may be provided as string supports. Preferably, the rocker elements are of different heights, preferably three different heights so that they may be arranged to provide an arced profile, with the tallest in the center, the shortest at the ends, and those of intermediate height between the tallest and the shortest rocker elements so that the profile of the tops of the rocker elements corresponds to the radius of the instrument's neck. The grooves of the rocker elements may be of different sizes to accommodate strings of different diameters.

The rocker elements are wedge-shaped in one dimension, coming to a knife-edge point at the bottom. They are preferably placed in a carrier element having a V-shaped groove into which they fit. The V-shaped groove is wider than the wedge of the rocker elements so the rocker elements have room to rock therein. The carrier has a groove or semi-circular groove in its bottom face. The carrier is supported within a base element. The base has a curved or semi-circular groove in its top face. This allows the carrier element to be seated atop a piezoelectric element, preferably a coaxial piezoelectric element having a circular diameter, preferably by means of a curved or semi-circular groove which fits over the top of the piezoelectric element, and for the bottom of the piezoelectric element to be placed within a curved or semi-circular groove in the recess of the base, and for the curved grooves to be sized so that there is a gap between the carrier and the portion of the base into which it fits to ensure that the piezoelectric element is compressed within the grooves. The carrier element transfers acoustic vibrations form the rocker element directly to the transducer.

The rocker elements preferably have shoulders on which a capturing piece can be placed to prevent the rocker elements from falling out of the V-shaped grooves. The capturing piece is equipped with apertures placed to allow the rocker elements to protrude up through it.

The V-grooves into which the rocker elements fit may be variably positioned to facilitate achieving a desired intonation for the musical tone of the strings.

This invention also comprises kits comprising a number of rocker elements, e.g. six for a six-stringed guitar, grooved appropriately to accommodate the diameters of the strings, and with three different heights designed to form an arced profile. Carrier elements having V-shaped grooves in different positions to provide selected intonations are also provided. Such kits may also include other components of this invention, including a base and capturing piece. Further, components such as strings and piezoelectric element(s) may be provided as well as fastening means such as screws for attaching the base of the bridge to the instrument.

This invention may comprise a portion of a system which also comprises an automatic tuner or tremolo device, and/or a stringed musical instrument, amplifier, analyzer or other means for modifying the sound of the instrument, such as to make an acoustic guitar sound like an electric guitar or vice versa.

This invention also comprises a method of making a bridge for a stringed instrument or a system as described above comprising providing and assembling the above components.

This invention provides a device which allows tension of a string of a musical instrument to be increased or decreased without increasing or decreasing the vibrational length of the string, said device comprising a rocker element having an arced groove therein across which the string may be placed, the rocker element being placed within a carrier with V-shaped groove. The rocker element fixes the tangential contact point of the string directly above the knife-edge pivot, thereby holding the vibrational length constant.

The pivot point within the V-shaped groove facilitates substantially frictionless motion. Acoustic vibrations are transferred from the string to the base or carrier via the rocker element which has grooves of varying sizes to support strings of varying diameters. The rocker elements are preferably also made in differing heights so as to support the strings in an arced profile which matches the contour of the neck of the instrument and preferably have shoulders which allow them to be captured by the capturing element, which has apertures through which the rocker elements protrude.

The carrier elements preferably provide a channel for firmly capturing the piezoelectric element, have variably positioned V-shaped grooves to facilitate achieving desired intonations; have variably positioned V-shaped grooves to facilitate angled placement to provide proper alignment between the string and groove; and have variable widths for adjusting string spacing.

The base provides a groove, channel, or recess for the piezoelectric element and preferably has a recess into which a separate carrier element may be fitted.

### BRIEF DESCRIPTION OF THE DRAWINGS

FIG. 1 is a front view of the piezo rocker bridge of this invention. FIG. 2 is a cross-sectional view along line A-A of FIG. 1. FIG. 3 is a perspective view of a rocker element of this invention. FIG. 4 is a side view of a rocker element of this invention. FIG. 5 is a perspective view of the carrier element of this invention. FIG. 6 is a side view of the carrier element.

### DETAILED DESCRIPTION

The device of the invention provides piezoelectric transducer outputs for devices that require string movement, such as automatic tuning systems and tremolo devices. The device facilitates string movement at the bridge while keeping the string length constant, frictionless string movement via the knife-edge pivot of the rocker element, and maximum transfer of acoustic energy from the string to the transducer by minimizing the number of material interfaces between the string and the piezoelectric element. The device further provides adjustability for string intonation, string position for matching to curvature of the neck, string spacing and string height.

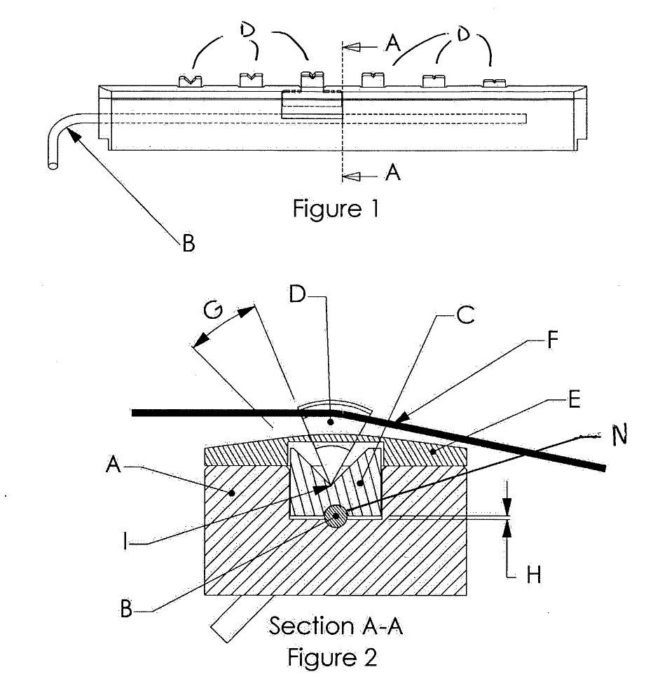

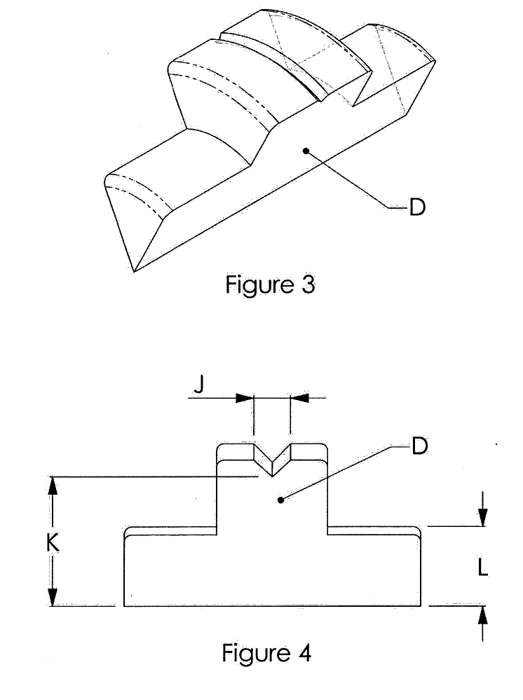

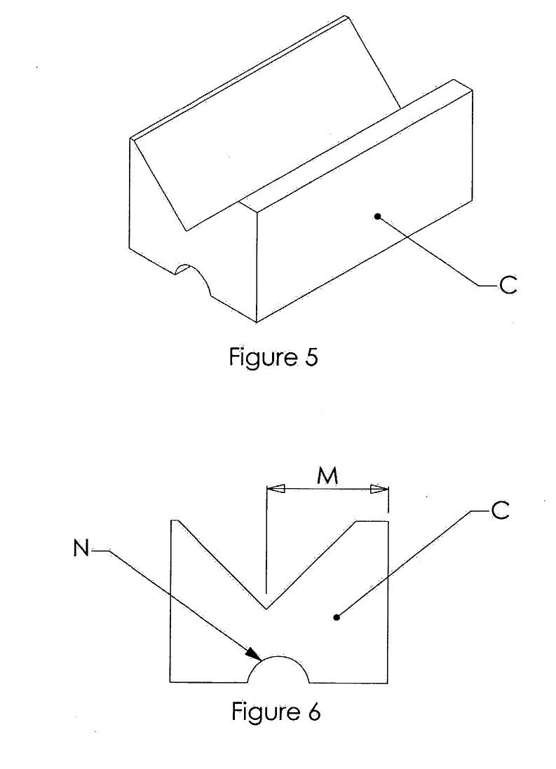

FIG. 1 is a front view of the piezo rocker bridge of this invention. The tops of the six rocker elements D comprising grooves to receive guitar strings are shown arranged in an arc so as to allow the strings to follow the curvature of the neck of the guitar to which the bridge is to be attached. In a preferred embodiment, the rocker elements are of differing heights, with the end rocker elements being shortest, the center rocker elements being tallest, and the rocker elements between the end and the center rocker elements being intermediate in height. The rocker elements are equipped with different sized grooves to accommodate conventional guitar strings having different diameters. Coaxial piezoelectric element B is shown exiting the side of the bridge.

FIG. 2 is a cross-sectional view of the bridge along line A-A of FIG. 1. A is the base of the bridge, comprising a square-shaped recesses at the top for seating carriers C and semi-circular grooves at the bottom of said recesses matched to corresponding semi-circular grooves N in carrier C to create a channel for coaxial piezoelectric element B. When coaxial piezoelectric element B is in place, there should be a gap H between carriers C and base A to allow the carriers to compress the coaxial piezoelectric element. Capturing piece E is placed over the tops of the base and captures the shoulders of rockers D (see FIGS. 3 and 4) and contains apertures shaped to allow rocker elements D to emerge through the capturing piece and to rock freely in the V-shaped grooves in carriers C. A string F is placed in the upper groove of each rocker element D. The V-shaped rocker element D is less wide than the V-shaped groove of carrier C, allowing an angular space G on either side through which it is free to move. Each rocker element D rests in the V-shaped groove of carrier C at a knife pivot point I so that the string vibration length is fixed at the tangent point above the knife pivot point as the rocker element moves through its arc.

FIG. 3 is a perspective view of the rocker element. The raised center portion is grooved to receive a guitar string, and the corners are preferably chamfered.

FIG. 4 is a side view of the rocker element of FIG. 3. Each rocker has a shoulder height L. Capturing piece E captures the shoulders of each rocker element. Each rocker has a string placement height K which varies so that the strings can be placed in an arc as shown in FIG. 1 designed to follow the contours of the guitar neck.

FIG. 5 is a perspective view of the carrier element of this invention showing the V-shaped groove at the top for receiving the rocker element and the semi-circular groove at the bottom for creating a channel for the coaxial piezoelectric element.

FIG. 6 is a side view of the carrier element. The distance M from the bottom of the V-shaped groove to the edge of the carrier may vary to adjust intonation.

In use, the bridge of this invention comprising base A is placed on the face of a conventional acoustic or electric guitar or other stringed instrument. Coaxial piezoelectric element B is laid into the semicircular groove in base A, and carriers C are placed into the recesses in base A with the grooves N in the bottom of each carrier C riding on the coaxial piezoelectric element leaving a gap H between the bottom of carrier elements C and base A. The piezoelectric element traverses the base of the bridge and extends out of the base. It may be connected to any standard piezoelectric pre-amp circuit. Carriers C may be selected with dimensions M designed, as will be appreciated by those skilled in the art, to provide the desired intonation for each string. Rocker elements D, typically having different heights and different size string grooves, are placed into the V-shaped grooves of carriers C. The rocker elements D are arranged so that their tops form an arc following the arc of the guitar neck. Capturing piece E is placed over the bridge such that its bottom captures the shoulders of the rocker elements D and the tops of the rocker elements D extend through apertures in the capturing piece E. Strings F are placed into string grooves on the tops of rocker elements D.

When string tension is changed, e.g. to produce tremolo, or change the frequency of the string, the rocker element beneath the string moves within the V-shaped groove of its carrier C such that the point where the string F is tangent to the curved top of the rocker element D is a constant distance from knife pivot point I where the bottom of the rocker element D rests in the V-shaped groove of carrier C such that a constant vibrating string length is maintained.

The rocker of this invention is an improvement over the use of rollers to produce constant string length because it reduces friction. The rocker contacts the carrier piece at only one point and the vibration is transmitted directly through the carrier element to the piezoelectric element.

The device described herein can be manufactured with appropriate connection means to sit directly on the face of an acoustic guitar, and/or to replace the saddle of any acoustic guitar. It may also have interconnect means such that it can be supported on adjustable bridge posts common to most electric guitars to provide string height adjustment. It can also be manufactured with appropriate interconnect means to replace most common electric guitar bridges.

The piezoelectric element described herein is round, but can be any shape known to the art, sheet, square, and the like, in which case the grooves in the base and carrier can be modified to fit the piezoelectric element. The piezoelectric element can also be of any type known to the art, coaxial, crystal, etc. The piezoelectric element may be comprised of a single piezoelectric element such as a coaxial or strip element, or individual elements for each string so that discrete string frequencies can be acquired for use in triggering synthesizers, etc. Adjustable intonation can be achieved by using a flat piezoelectric element and sliding the carrier over the top of the piezoelectric element. The output of the piezoelectric element can be electronically blended with any other type of pickup output such as a magnetic or optical pickup. Spacing between the carrier and the base element is designed to produce a compressing force on the piezoelectric element which provides maximum acoustic-to-electric transfer.

The bridge pieces may be manufactured from any art-known materials, depending on the sound desired. For example, metal parts produce a brassy tone; plastic parts produce a warmer tone.

In a further embodiment of the invention, the carrier and the base elements may be manufactured as one piece.

In a further embodiment of this invention, the rocker elements may comprise piezoelectric crystals operably connected to sound signal amplification, analysis or modification means, e.g. by means of a wire, in which case, the base and/or carriers need not be provided with grooves to form a canal for a coaxial piezoelectric element.

A system for adapting a musical instrument having strings to allow individual adjustment of string tension without changing string vibration length is provided comprising a bridge consisting of individual, moveable saddles for supporting said strings. The system also preferably comprises piezoelectric elements mechanically in vibrational contact with said strings.

Preferably said mechanical vibrational contact occurs through at most 1 to 3 interfaces between the strings and the piezoelectric elements.

The vibrational contact may occur through the interface between the string and a moveable saddle which comprises a piezoelectric crystal. Or the mechanical vibrational contact may occur first through the interface between the string and a rocker element, second through the interface between the rocker element and a carrier, third through the interface between the carrier and the coaxial piezoelectric element.

This invention also provides a method for changing the tension of a string of a stringed musical instrument without changing the vibrational length of said string, said method comprising: providing a bridge comprising a rocker element and a component comprising a V-shaped groove into which said rocker element is rockably placed as a moveable saddle in supportive contact with said string at a tangent point; changing the tension of the string; and allowing said rocker element to move in response to said changed tension, whereby said tangent point remains a constant distance from the bottom of said V-shaped groove and said vibrational string length is maintained.

Obviously, numerous variations and modifications can be made without departing from the spirit of the present invention. Therefore, it should be clearly understood that the form of the present invention described above and shown in the fogures of the accompanying drawing is illustrative only and in not intended to limit the scope of the present invention.

What is claimed is:

1. A moveable-saddle bridge to be used in conjunction with a piezoelectric pickup for stringed musical instruments, said moveable-saddle bridge providing frictionless travel of the strings over the individual bridge saddles, comprising:
a. rocker element for supporting said string;
b. carrier element for supporting said rocker;
c. base element for supporting said carrier;
d. capturing element for capturing said rocker and said carrier; and
e. means for element of said piezoelectric pickup to be mechanically in vibrational contact with said carrier and said base for converting vibrations transmitted to said piezoelectric pickup from said string to electronic impulses.

2. A bridge in accordance with claim 1, wherein said bridge is useful in combination with any musical instrument accessory that requires string movement at the bridge, such as automatic tuning systems and tremolo devices.

3. A bridge in accordance with claim 1, wherein said bridge holds string intonation length constant as said string tension is altered.

4. A bridge in accordance with claim 1, wherein said bridge maximizes the transfer of acoustic energy from said string to said piezoelectric pickup.

5. A bridge in accordance with claim 1, wherein said bridge provides a method by which the friction between said string and said moveable-saddle is eliminated therein allowing the string to return to its intended state of tuning following fretting or string bending during normal playing.

6. A bridge in accordance with claim 1, wherein said bridge can be used in conjunction with many types of stringed musical instruments, for example acoustic and electric guitars.

7. A bridge in accordance with claim 1, wherein said bridge is not exclusively dependent on the installation of said piezoelectric pickup.

8. A bridge in accordance with claim 1, wherein said piezoelectric pickup translates vibrations from said string of any stringed musical instrument to electronic means for amplification, sound reproduction, sound alteration, frequency acquisition or synthesizer triggering.

9. A bridge in accordance with claim 1, wherein the output of the said piezoelectric pickup can be electronically blended with any other type of pickup output such as a magnetic or optical pickup.

10. A bridge in accordance with claim 1, wherein said bridge utilizes said piezoelectric pickup of any type or shape known to the art, for example coaxial, rectangular, sheet, film, crystal, etc.

11. A bridge in accordance with claim 1, wherein said piezoelectric pickup can use various configurations of piezoelectric pickup elements, for example a single piezoelectric pickup element or a plurality of piezoelectric pickup elements.

12. A moveable-saddle bridge to be used in conjunction with a piezoelectric pickup for stringed musical instruments, said moveable-saddle bridge providing frictionless travel of the strings over the individual bridge saddles, comprising:
a. a plurality of said strings;
b. said supporting means comprises a plurality of said rocker elements; and
c. said supporting means comprises a plurality of said carrier elements;

13. A bridge accordance with claim 12, wherein said bridge includes adjustment means for adjusting the spacing between the strings, string position for matching to curvature of the neck and string diameters.

14. A bridge accordance with claim 12, wherein said bridge is useful in combination with any musical instrument accessory that requires string movement at the bridge, such as automatic tuning systems and tremolo devices.

15. A bridge accordance with claim 12, wherein said bridge holds string intonation length constant as said string tensions are altered.

16. A bridge accordance with claim 12, wherein said bridge maximizes the transfer of acoustic energy from said strings to said piezoelectric pickup.

17. A bridge accordance with claim 12, wherein said bridge provides a method by which the friction between the strings and bridge saddles are eliminated allowing the strings to return to their intended state of tuning following fretting or string bending during normal playing.

18. A bridge accordance with claim 12, wherein said bridge is useful for all types of stringed musical instruments, for example acoustic and electric guitars.

19. A bridge accordance with claim 12, wherein said bridge translates vibrations from the strings of any stringed musical instrument to electronic means for amplification, frequency acquisition, sound reproduction, sound alteration or synthesizer triggering.

20. A bridge accordance with claim 12, wherein output of said piezoelectric pickup can be electronically blended with any other type of pickup output such as magnetic or optical pickups.

21. A bridge accordance with claim 12, wherein said bridge can utilize piezoelectric pickup elements of any type or shape known to the art, for example coaxial, rectangular, sheet, film, crystal, etc.

22. A bridge accordance with claim 12, wherein said bridge that can utilize various configurations of said piezoelectric pickup elements, for example a single piezoelectric pickup element or a plurality of piezoelectric pickup elements.

23. A bridge accordance with claim 12, wherein said bridge is not exclusively dependent on the installation of the piezoelectric pickup element.
